(19) United States
(12) Patent Application Publication
(10) Pub. No.: US 2025/0388786 A1
(43) Pub. Date: Dec. 25, 2025

(54) WASH-OFF LABEL

(71) Applicant: UPM Raflatac Oy, Tampere (FI)

(72) Inventors: Sari PIRKKANEN, Helsinki (FI); Tibor PERNECKER, Helsinki (FI)

(21) Appl. No.: 18/880,428

(22) PCT Filed: Jul. 1, 2022
(86) PCT No.: PCT/FI2022/050485

§ 371 Date: Dec. 31, 2024

(51) Int. Cl. C09J 11/08; B65D 23/14; C09J 7/24; C09J 7/25; C09J 7/38; G09F 3/02; G09F 3/10

(52) U.S. Cl. CPC C09J 11/08; B65D 23/14; C09J 7/243; C09J 7/255; C09J 7/385; G09F 3/02; G09F 3/10; C09J 2203/334; C09J 2301/302; C09J 2301/408; C09J 2423/106; C09J 2467/006; C09J 2467/008; G09F 2003/0225; G09F 2003/0241; G09F 2003/0242; G09F 2003/0273

(57) ABSTRACT

The invention relates to a method for manufacturing a wash-off label (2) comprising a face (1) and a pressure sensitive adhesive layer (4), wherein the face (1) comprises a thermoplastic film, and the method comprises applying an acrylic adhesive onto a first surface of the face (1), wherein the acrylic adhesive comprises a wash-off additive, the wash-off additive comprising are sinous material, and a grafted rosin ester which is a rosin ester grafted with a capped polyalkylene glycol, wherein the capped polyalkylene glycol is apolyalky lene glycol end-capped by an alkyl ether, and drying the acrylic adhesive in order to form an acrylic pressure sensitive adhesive onto the first surface of the face (1), thereby obtaining the wash-off label (2). The invention further relates to a wash-off label.

### TECHNICAL FIELD

The application relates to wash-off labels. The application further relates to a method for manufacturing a wash-off label.

### BACKGROUND

It is general practice to apply a label to a surface of an item to provide decoration, and/or to display information about the product being sold, such as the content of the item, a trade name or logo. Alternative type of labelling technologies and labels are available, such as pressure-sensitive, wet glue, wrap around and shrink sleeve labels. The containers, such as bottles in the beverage industry, are generally re-used or recycled. Therefore, there is a need for labels which are easily removed from the surface of the container during washing processes such as hot dilute caustic soda. Thus, removable labels are an important topic, for example, in beverage industry.

### SUMMARY

It is an object of this application to provide a wash-off label. Another object is to provide a combination of a label and an item, wherein the item is afterwards recycled or reused. Yet another object is to provide a method for manufacturing a wash-off label.

Aspects of the invention are characterized by what is stated in the independent claims. Some preferred embodiments are disclosed in the dependent claims. These and other embodiments are disclosed in the description and figures.

Conventionally, washing temperatures of wash-off processes have been around +85° C. Due to environmental and cost reasons, nowadays a new target is to decrease washing temperature to +65° C. However, washing temperatures below 70° C. have been particularly challenging for filmic PSA labels.

A wash-off label according to this specification comprises a face and a pressure sensitive adhesive layer for adhering the wash-off label to a surface of an item to be labelled. The face according to this specification can comprise a thermoplastic film, preferably an oriented thermoplastic film.

The pressure sensitive adhesive layer of the wash-off label can comprise an acrylic pressure sensitive adhesive which comprises a wash-off additive. The wash-off additive can comprise a resinous material, preferably selected from a group consisting of a hydrocarbon resin, an alkyd resin, a polyamide resin, a rosin resin, and mixtures thereof, and a grafted rosin ester which is a rosin ester grafted with a capped polyalkylene glycol. The capped polyalkylene glycol is a polyalkylene glycol end-capped by an alkyl ether, preferably the capped polyalkylene glycol is a methyl ether capped polyethylene glycol. Thanks to the novel wash-off additive, washability of the wash-off label comprising an acrylic adhesive was substantially improved. Surprisingly, the novel wash-off label comprising the modified adhesive comprising the acrylic adhesive and the wash-off additive clearly improved acrylic polymer wash-off properties in low temperature washing processes at +65° C., even when using low alkaline water of 1%.

For improving efficiency of the wash-off additive, an amount of the wash-off additive can be more than 0 wt. %. The wash-off additive can start to improve washability of the wash-off label even when a very small amount of more than 0 wt. % is used. The effect of the wash-off additive can start to decrease when the amount of the wash-off additive exceeds 3 wt. %. The amount of the wash-off adhesive can be equal to or less than 3 wt. %, preferably the amount of the wash-off adhesive is from equal to or more than 0.5 wt. % to equal to or less than 3 wt. %, calculated from total dry weight of the acrylic adhesive. In an advantageous example, the amount of the wash-off additive is in a range between 0.7 wt. % and 2.5 wt. %, calculated from total dry weight of the acrylic adhesive.

The novel wash-off label can be easily removed during a washing process comprising a temperature at 65° C. and alkaline conditions. Thus, the wash-off time of the wash-off label may be substantially decreased at said conditions, compared to solutions without the wash-off additive. Furthermore, thanks to the novel solution, the wash-off time of the wash-off label can be decreased.

For improving washability of the wash-off label, a molar ratio between the rosin ester and the capped polyalkylene glycol can be 0.05:1 to 1:1, preferably at least 0.4:1, and most preferably from 0.7:1 to 0.9:1.

In order to further improve washability of the wash-off label, an amount of the grafted rosin ester with respect to the resinous material can be from about 1 wt. % to about 8 wt. %. In an advantageous embodiment, the resinous material comprises or is the rosin resin.

Furthermore, for the improved washability, the preferred polyalkylene glycol is a polyethylene glycol, and the alkyl ether is preferably a methyl ether. Most preferably, the capped polyalkylene glycol is a methyl ether capped polyethylene glycol for efficient and fast washing process of the wash-off label.

The acrylic wash-off adhesive comprising the acrylic adhesive and the wash-off additive can cause adhesion of the pressure sensitive adhesive to the labelled item to be efficiently decreased during a washing process so that the PSA can still remain attached to the face. Preferably, the acrylic adhesive comprises 2-ethylhexyl acrylate (2-EHA) (s) as the wash-off adhesive can efficiently improve washability of the acrylic adhesive comprising 2-ethylhexyl acrylate.

The thermoplastic film can be an oriented thermoplastic film, such as a monoaxially oriented film or a biaxially oriented film, preferably the biaxially oriented film. The oriented thermoplastic films can provide improved mechanical properties to the direction of the orientation, compared to non-oriented thermoplastic films.

Thus, the wash-off label can comprise the monoaxially oriented thermoplastic film, such as a monoaxially oriented polypropylene film. The monoaxially oriented thermoplastic film can be monoaxially oriented in machine direction of the film. Alternatively, the monoaxially oriented thermoplastic film can be monoaxially oriented in transverse direction of the film. Thanks to the monoaxially oriented film, mechanical properties of the thermoplastic film can be improved at least to said one direction, which can facilitate the processability and handling of the films in the process.

The wash-off label can comprise the biaxially oriented thermoplastic film, such as a biaxially oriented polypropylene film. Biaxially oriented thermoplastic films can provide improved mechanical properties for both directions of the film. This can improve easiness of handling the films in the manufacturing process as well as in the washing processes.

The face can be configured to shrink, preferably asymmetrically. This can allow reducing the wash-off time of the wash-off label.

The face can comprise a polypropylene film. Polypropylene is well compatible e.g. with polyethylene, and using such similar polymers can provide a good adherence of the label to the article. Stiffness of polypropylene can be, e.g., smaller than a stiffness of polyester which can result in less flagging or winging on curved bottles. Some articles, such as soft bottles, can require such flexibility.

The face can comprise a glycol modified polyethylene terephthalate film. The glycol modified polyethylene terephthalate PETG can have an effect on flexibility of the face.

A method for manufacturing the wash-off label can comprise the following steps:
applying an acrylic adhesive onto a first surface of the face, wherein the acrylic adhesive comprises the wash-off additive according to this specification, and
drying the acrylic adhesive in order to form an acrylic pressure sensitive adhesive onto the first surface of the face, thereby obtaining the wash-off label.

A polymer gel content of the water-based acrylic adhesive can be at least 20%, preferably in a range between 60% and 75%. This polymer gel content, and particularly the range from 60% to 75%, can improve adhesion performance of the acrylic adhesive.

A mean particle size of the water-based acrylic adhesive can be at least 100 nm and 800 nm at the most, measured as a mean particle diameter. Thanks to said range, properties of the acrylic adhesive, such as a solid content and a viscosity level of the acrylic adhesive, can be controlled and adjusted to a desired level.

The wash-off label according to this specification can be adhered to a surface of an article, such as a beverage bottle. Thus, the wash-off label according to this specification can be used for labelling a beverage bottle.

In the washing process, the pressure sensitive adhesive comprising the wash-off adhesive, which is sensitive to the washing conditions, is efficiently detached from the labelled item. Thanks to the novel solution, adhesion of the adhesive efficiently decreases at the washing process, providing a technical effect of detaching the label efficiently from the item. Further, the novel solution can provide an effect of efficiently preventing the detached labels from sticking to each other by the adhesives and forming agglomerates.

Thanks to the novel solution, the pressure sensitive adhesive can be easily and fast deactivatable at a temperature at 65° C. and alkaline conditions. The alkaline conditions refer to an aqueous solution containing alkaline agent, such as NaOH, KOH, LiOH, MgOH, CaOH, or combination thereof. Probably the most common alkaline agent is sodium hydroxide NaOH, which is also called caustic soda. The alkaline liquid generally contains about 2-4% (w/w) of the alkaline agent(s), for example about 2%. However, thanks to the novel solution using the acrylic adhesive comprising the wash-off additive, alkaline conditions of down to 1%, such as down to 1% NaOH, can be used together with the washing temperature of 65° C. for obtaining suitable washing conditions for efficiently washing off the wash-off label according to this specification.

Therefore, thanks to the novel wash-off label according to this specification, washing conditions can be more environmentally friendly than conventionally. Furthermore, the wash-off label can be recycled cost-efficiently.

Still further, thanks to the novel solution, lifetime of the washing solution can be prolonged and the contamination of the recyclable items, such as bottles, can be prevented.

### BRIEF DESCRIPTION OF THE DRAWINGS

In the following, the invention will be described in more detail with reference to the appended drawings, in which:

FIG. 1 shows, in a perspective view, an example embodiment of a wash-off label,

FIG. 2 shows a cross section of a wash-off label laminate comprising die-cut labels, and

FIG. 3 shows a labelled item comprising a wash-off label.

The Figures are intended to illustrate the general principles of the disclosed solution. Therefore, the illustrations in the Figures are not necessarily in scale or suggestive of precise layout of system components.

### DETAILED DESCRIPTION

The solution is described in the following in more detail with reference to some embodiments, which shall not be regarded as limiting.

The following reference numbers and denotations are used in this application:
Sx, Sy, Sz orthogonal directions
MRK1 marking, such as a printing,
DIR1 first direction,
DIR2 second direction,
1 a face,
2 a wash-off label,
4 an adhesive layer,
5 a release liner,
6 a release layer,
7 a substrate,
8 a label laminate,
100 an item,
101 a labelled item

The embodiments and examples recited in the claims and in the specification are mutually freely combinable unless otherwise explicitly stated.

In this specification, the term “comprising” may be used as an open term, but it also comprises the closed term “consisting of.” Thus, unless otherwise indicated, the word “comprising” can be read as “comprising or consisting of”.

For the purpose of the present description and the claims, unless otherwise indicated, all ranges include any combination of the maximum and minimum points disclosed, and include any intermediate ranges therein, which may or may not be specifically enumerated herein.

Percentage values relating to an amount of a material are percentages by dry weight (wt. %) unless otherwise indicated.

Term “web” refers to a continuous sheet of material. The web is generally processed by moving over rollers. Between processing stages, webs may be stored and/or transported as rolls.

Term “machine direction” (MD) refers to manufacturing direction of a web, i.e., running direction of the face or continuous label laminate during label manufacturing. In case of a rolled web, machine direction refers to a circumferential direction of the roll. Further, longitudinal direction of a web refers to the machine direction. MD may be equal to direction DIR1 of the label attached on the surface of an item.

Terms “cross direction” (CD) and “transverse direction” TD refer to a direction that is transversal to the machine direction. Thus, “transverse direction” TD and “cross direction” CD refer to the direction perpendicular to the running direction of the face or label laminate.

Term “gsm” refers to g/m².

Term “PET” refers to polyethylene terephthalate, and “PET bottle” refers to a polyethylene terephthalate bottle.

In this specification term “label” refers to a piece of material, which is used for labelling of an item. Label may be used to identify something. Label may be attached to an article. An article may be a package, such as a bottle. In other words, label is suitable to be applied to a surface of an item to provide decoration, and/or to display information about the product being sold, such as content information, a trade name, a logo, a barcode, or any other graphics.

The label according to this specification is a wash-off label. Term “wash-off label”, also referred to as a washable label, refers to a label removable (detachable) from the surface of the item attached during subsequent washing process. At washing conditions having a temperature of 65° C., the adhesive bond between the label and the item the label is adhered to is weakened. The chemical effect of the washing solution may further promote the weakening of the adhesion. A wash-off label may comprise an adhesive layer sensitive to washing conditions. Wash-off labels may be used in labelling of beverage bottles. The wash-off label according to this specification can be particularly suitable for polyethylene terephthalate (PET) bottles.

Term “face” refers to a substrate of the wash-off label, also called as a face stock or a face material.

In this specification, the term “adhesive coating” refers to a coating comprising an acrylic adhesive.

Term “PSA” refers to pressure sensitive adhesive(s). PSA according to this specification is an acrylic pressure sensitive adhesive.

Term “PEG” refers to polyethylene glycol(s).

A ratio of total film thickness before and after stretching (orientation) is called a “stretch ratio” or “stretching ratio”. It may also be referred to as an orientation ratio. Stretch ratio is a non-oriented (undrawn) film thickness in relation to the oriented (drawn) film thickness. The non-oriented film thickness is the thickness after extrusion and subsequent chilling of the film. When stretching the film, the thickness of the film may diminish in the same ratio as the film stretches or elongates. For example, a film having thickness of 100 micrometers before uniaxial orientation is stretched by a stretch ratio of 5. After the uniaxial orientation, the film may have a fivefold diminished thickness of 20 micrometers. Thus, the stretch ratio (orientation ratio) is 5.

Term “shrinkable” refers to a property of a plastic film to shrink under exposure to external energy. A shrinkable film may shrink when exposure to an elevated temperature. Heat may be applied via washing liquid. In response to application of heat, the heat shrinkable film is arranged to shrink.

Shrinkage can be measured according to the following method: providing a sample with measured and marked 100 mm*100 mm area, placing the sample for 5 minutes to the caustic washing liquids having temperatures at intervals of 5° C. from 55° C. to 95° C., cooling the sample at water bath having temperature of around room temperature, drying the sample, and measuring the dimensions of the marked area of the sample. Preferably at least 3 or more parallel samples are used. Shrinkage is determined as the relative change of dimensions.

Polymer gel content can be measured by using Dionex ASE 150 Solvent Extractor according to the following method: Dionex ASE 150 Solvent Extractor has the following settings: Temperature—100° C., Static Time—30 min, Rinse Volume—10%, Purge time—60 seconds, Cell volume—66 mL.

Equipment: 66 mL cell, 80 mm×25 mm cellulose thimble, and acetone.

The method has the following steps:
1) Weight dry thimble
2) Add ˜1-1.5 g wet adhesive to thimble by coating the inside in a thin film
3) Dry in oven until no moisture left
4) Weigh thimble +dry adhesive and insert into the 66 mL cell
5) Run through extractor process
6) Remove thimble and dry in the oven until all the acetone is gone
7) Repeat steps 5 and 6 two more times for a total of 3 cycles
8) Dry the thimble one final time and measure weight
9) With the values from steps 1, 4 and 8, calculate polymer gel content percent as follows:
Polymer gel content=100*(T_{AB}−T)/(T_{AA}−T)
in which
Thimble dry weight=T
Thimble+adhesive before extraction dry weight=T_{AB}
Thimble+adhesive after extraction dry weight=T_{AA}
Adhesive before extraction weight=T_{AB}−T
Adhesive after extraction weight=T_{AA}−T.

### Wash-Off Label

A wash-off label 2, also referred to as a washable label, refers to a label removable (detachable) from the surface of the item attached to during subsequent washing process. A wash-off label can comprise a pressure sensitive adhesive layer 4 sensitive to washing conditions.

Wash-off label according to this specification can be washable at a washing temperature of 65° C., wherein washing liquid is from about 1% to about 4%, preferably from about 1% to about 2%, and most preferably about 1% alkaline water. The washing liquid can comprise caustic soda, for example sodium hydroxide.

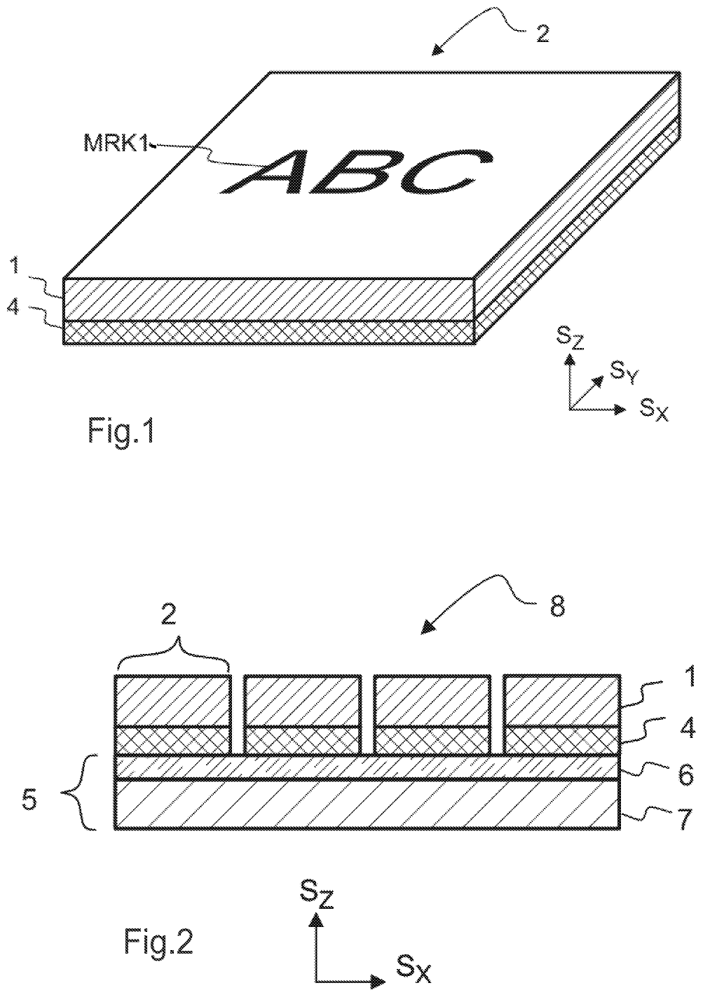

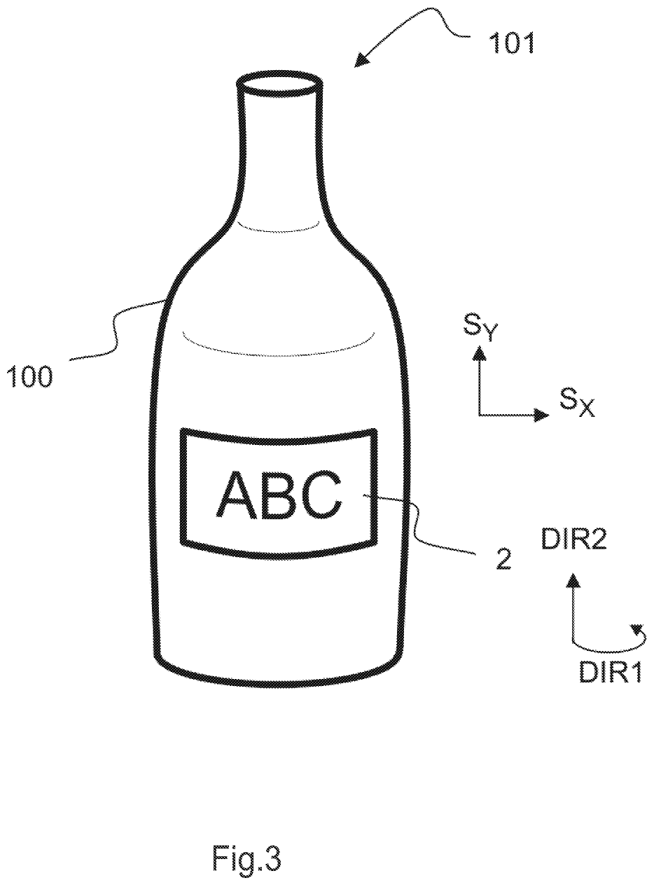

Referring to FIGS. 1-2, a wash-off label can comprise a face 1 and an adhesive layer 4 on the face for adhering the label to the surface of an item to be labelled.

The wash-off label 2 can comprise at least the following layers: the face 1, the acrylic PSA layer 4, and a print layer MRK1. Individual labels 2 can be die-cut from a continuous label web.

Referring to FIG. 2, the wash-off label 2 can be a label laminate comprising a release liner 5. The release liner can protect the adhesive layer before the label is adhered to a surface of an item.

Alternatively, and referring to FIG. 1, the wash-off label can be a linerless label without the release liner 5. Elimination of release liners reduces the material costs of the labels but also avoids the disposal of the release liner after the labelling. Moreover, the exclusion of the release liner decreases the thickness in a roll of labels and more labels can be provided per roll. Thus, the wash-off label can be a linerless wash-off label, such as a printed linerless wash-off label.

If the wash-off label is the linerless label without the release liner 5, there is preferably a release layer on top of the face for preventing adjacent layers of a linerless label roll for attaching to each other. The release layer is preferably a layer which does not cause problems for the washing process, such as a silicone based layer.

The wash-off label can comprise the following layers, preferably in the following order:
optionally, a release layer comprising a release agent, such as a silicone,
a face comprising an oriented thermoplastic film, and
an adhesive layer comprising a wash-off additive and an acrylic pressure sensitive adhesive capable of forming a bond when pressure is applied at a room temperature.

The wash-off label can be a printed wash-off label. The printing MRK1 may be subsequently top coated or laminated in order to protect the printing. Alternatively or in addition to the top coating and/or laminating, the reverse side of the face adjacent to the adhesive layer 4 may be printed. Print layer is to be understood to include also decorations made by, for example, metallic or metallic like layers if such decorations are used in the label.

Thus, the wash-off label 2 comprises at least the face 1 comprising one or more layers, at least one adhesive layer 4, and optionally a release liner 5. The adhesive layer 4 comprises PSA. The PSA is used to enable the label to be attached to an item, an article, or a container.

The wash-off label may further comprise one or more additional layers, such as a primer layer. The primer layer may be arranged in between the face and the adhesive layer. The primer layer may be arranged to increase the adherence of the adhesive layer to the face.

In an embodiment, density of the wash-off labels is adjusted to a total average density of less than 1.0 g/cm³. This causes the labels to float in an aqueous solution. For example in a case of PET bottles wherein recycling methods include crushing or shredding of plastic bottles, the bottle may sink while the wash-off label can float, thus allowing for efficient recovery and recycling of the PET flakes. Therefore, as pieces of shredded plastic bottles sinks, this can allow the labels to be separated from the bottles easily, particularly when using said total average density together with the wash-off adhesive allowing the PSA to separate from bottles efficiently at 65° C. in alkaline conditions.

### Face

The face 1 is adhered to the surface of an item during labelling through an adhesive layer 4. The face 1 comprises a first surface and a second surface. The first surface can refer to an adhesive side while the second surface can refer to a top side.

The face can comprise a layer comprising a thermoplastic film. Thus, the face may comprise a face film. The face film may be a monolayer. Alternatively, the face film may have a multilayer structure including two or more layers.

The labels comprising a thermoplastic face, in contrast to the paper based, have e.g. a superior wet strength and transparency, and they can be dispensed onto the bottles and other containers in standardized machines, without a need to work with separate adhesives, as for example in the case of the wet-glue paper label. Furthermore, thanks to the face comprising the thermoplastic film instead of a paper, lifetime of the washing solution can be substantially prolonged.

The thermoplastic film may be provided through extrusion. Multilayer structure may be provided through coextrusion so as to provide uniform film structure, wherein the adjacent film layers are in direct contact with each other.

Thus, the face may comprise two or more layers of thermoplastic films. Preferably, for environmental reasons as well as for improving cost efficiency, the face can have only one thermoplastic film or only two thermoplastic films.

The thermoplastic film(s) of the face is/are preferably oriented. The oriented film may be provided, for example, by uniaxial or biaxial stretching. Thanks to the oriented film(s), handling of the face may be easier than without the orientation. Furthermore, mechanical properties of the label can be improved, which can also affect to the washing of the wash-off label. Still further, due to the orientation, the film can exhibit controllable shrinkability at elevated temperatures. Elevated temperature can be applied in the form of heated washing liquid having, e.g., a temperature of 65° C.

For providing cost-efficient process with easily controllable film-structure, all thermoplastic layers of the face have preferably the same orientation if the face has a multilayer structure.

As discussed, the face can comprise a uniaxially oriented or biaxially oriented thermoplastic film. Uniaxially oriented film is preferably oriented in the machine direction. Machine direction orientation has effect on enabling sufficient mechanical properties required in dispensing lines of the labels, wherein the labels are separated from the supporting liner and applied onto the surface of an item.

Preferably, the face comprises the biaxially oriented thermoplastic film. The biaxial orientation and shrinkage of the film in two directions can have an effect on a removal profile of the wash-off label. When this film is brought up to the elevated temperatures during the washing, the film can shrink back towards the non-stretched state in both directions. This can improve efficiency of the washing process of the wash-off label and allow reducing the wash-off time of the wash-off label. Thus, biaxial orientation and shrinkage of the film may allow reducing the wash-off time of the label when compared to monoaxially oriented film.

The face may comprise a thermoplastic film having asymmetric orientation. Asymmetric orientation refers to the degree of orientation being different in the two orienting directions. Biaxial asymmetric orientation without annealing and/or with controlled thermal treatment may have effect on providing predetermined and non-uniform shrinkage capability for the face, which can further improve washability of the wash-off label.

The face may comprise a biaxially oriented thermoplastic film having asymmetric orientation. An asymmetric shrinkability of the biaxially oriented thermoplastic film has effect on performance of the label both in labelling phase and subsequent phase of label removal from the surface of the item labelled. Asymmetric orientation can have an effect on providing efficient removability of the label from the surface attached. Asymmetric shrinkability and a higher shrinkage in transverse direction can also have effect on enhancing the separation of the label attached to a cylindrical bottle shape having convex surface.

The thermoplastic film(s) of the face may exhibit at least 20% shrinkage at 65° C. in the transverse direction. Alternatively or in addition, the thermoplastic film(s) of the face may exhibit at least 20% shrinkage at 65° C. in the machine direction. In an embodiment, the thermoplastic film(s) of the face exhibits shrinkage of between 20 and 80% in the machine and/or cross direction(s) of the film, at 65° C. Said shrinkage of the thermoplastic film(s) of the face can have effect on capability of the label to be washed off from the surface labelled. Further, said shrinkage can have effect on enabling more efficient and quick removal of the label from the surface of the item attached during washing process. Shrinkage of the thermoplastic film applies stresses, such as contraction tension, on the adhesive bond between the adhesive layer and the surface of the item labelled thus enhancing or enabling the removal of the label from the surface labelled.

Below 55° C., preferably below 60° C., shrinkage of the thermoplastic film of the face can be less than 5%, preferably less than 2%, for example between 0 and 5%, or between 0.1 and 2%, in both directions (MD/CD). Low shrinkage at temperatures below 55° C., preferably below 60° C., can have effect on avoiding unwanted shrinkage of the labels during storage or during label converting steps, for example during printing. Further, if the shrinkable thermoplastic film has very low shrinkage below 55° C., preferably below 60° C., shrinkability level of the film can be remained at substantially same level until the washing process.

The thermoplastic film(s) of the face may be transparent or clear. From the optical point of view, high transparency of the labels can be preferred. For example, in applications where the objects beneath the label, i.e. the surface of a bottle, should be visible through the label. The haze of the film(s) may be lower than 25%, or lower than 10%, for example 2-6%, or 4-5%. Haze is tested according to standard ASTM D1003. When the haze of the label is low also the adhesives are preferably clear or transparent.

Alternatively, one or more of the thermoplastic film(s) of the face may be, for example, opaque and/or white. In this embodiment, the face can comprise additive, such as a pigment, to provide a desired color. In a multilayer film structure, the additive may be included in one or more of the layers.

As discussed, the film(s) of the face comprise(s) thermoplastic polymer(s). The thermoplastic film(s) can comprise, for example, at least one of polyethylene terephthalate PET, polyvinyl chloride PVC, polystyrene PS, polypropylene PP, polyethylene PE, polylactic acid PLA and cyclic olefin copolymers COG.

The thermoplastic film(s) of the face may comprise a polyester film, such as a polyethylene terephthalate PET film. PET may be modified. The modified PET may be glycol modified PETG. In PETG the ethylene glycol unit(s) of the polymer backbone may be replaced, for example, with cyclohexane dimethanol CHDM and/or neopentyl glycol NPG. Thus, in an example, the thermoplastic film(s) of the face comprises glycol modified polyethylene terephthalate PETG. The glycol modified polyethylene terephthalate PETG can have effect on flexibility of the film. It can also have effect on ability of the film to be oriented. Still further the modification can have effect on reducing the brittleness of the thermoplastic film of the face. PETG can have effect on avoiding the stress whitening of the thermoplastic film, for example during application of the label. It can also have effect on transparency and clarity of the thermoplastic film.

Alternatively, or in addition to the polyester film, the thermoplastic film(s) of the face may comprise polypropylene and/or polyethylene film(s). The face may comprise, for example, an oriented polypropylene film and/or an oriented polyethylene film, which can be a biaxially oriented film. Said polyolefin films can improve easiness of handling of the film. Further, polypropylene can be less stiff than, for example, polyester. This reduced stiffness can result in reduced flagging or winging on curved bottles. Some containers can require such flexibility. Furthermore, biaxially oriented polypropylene and polyethylene films can have a density of less than 1.0 g/cm³, causing the film to float in wash-off processes. Thus, in wash processes, PET bottle flakes can sink while the label comprising e.g. oriented polypropylene film can float.

### Adhesive Composition

The wash-off label comprises a modified adhesive composition comprising an acrylic adhesive and a wash-off additive. The wash-off additive added into the acrylic adhesive can be in a form of an aqueous dispersion. The acrylic adhesive composition comprising the wash-off additive may be prepared by blending an acrylic adhesive and the wash-off additive.

An amount of the wash-off additive is more than 0 wt. %, calculated from total dry weight of the acrylic adhesive. For further improving efficiency of the wash-off additive, an amount of the wash-off additive can be at least 0.3 wt. %, preferably at least 0.5 wt. %, more preferably at least 0.7 wt. %, and most preferably at least 0.9 wt. %. The wash-off additive can start to improve washability of the wash-off label even when a very small amount of more than 0 wt. % is used. Further, the effect of the wash-off additive on the washability of the label can improve as the amount of the wash-off additive increases, at least up to 0.9 wt. %.

The effect of the wash-off additive can decrease when the amount of the wash-off additive exceeds 3 wt. %. Thus, the wash-off additive can be the most efficient when the amount of the wash-off adhesive does not exceed 3 wt. %. Thus, an amount of the wash-off additive may be equal to or less than 3 wt. %, preferably equal to or less than 2.7 wt. %, and more preferably equal to or less 2.5 wt. %, calculated from total dry weight of the acrylic adhesive. In an advantageous example, the amount of the wash-off additive is from 0.5 wt. % to up to 2.5 wt. %, calculated from total dry weight of the acrylic adhesive.

Thanks to the wash-off additive in the acrylic adhesive, washability of the PSA at 65° C. can be substantially improved.

As discussed, the adhesive according to this specification is an acrylic adhesive. Acrylics are a type of synthetic polymer which fall into the thermoplastic resin family. Acrylics provide strong, durable adhesion at normal temperatures and conditions. Acrylic adhesives are based on acrylic polymers, also called acrylate polymers. Acrylate monomers, used to form acrylate polymers, are based on the structure of acrylic acid, which comprises a vinyl group and a carboxylic acid terminus. Acrylic polymers are characteristically tacky, and they can be used as pressure sensitive adhesives without any modification. In general, acrylic adhesives have good aging and UV-resistance properties. They are polar in nature and therefore give good adhesion to polar substrates.

The acrylic adhesive can be in a form of an aqueous dispersion of acrylates having a solids content in a range between 40% and 60%. The higher solids content can provide an easier drying process.

Preferably, the acrylic adhesive coating comprises
butyl acrylate, or
2-ethylhexyl acrylate (2-EHA), or
butyl acrylate and 2-ethylhexyl acrylate (2-EHA).

Total content of the butyl acrylate and 2-hydroxyethyl acrylate may be at least 50 wt. %, more preferably at least 70 wt. %, more preferably at least 80 wt. %, and most preferably at least 85 wt. %, calculated from the dry weight of the acrylic adhesive. These acrylic adhesives may be particularly advantageous for wash-off labels.

In an embodiment, the acrylic adhesive comprises at least 80 wt. % (by dry weight) 2-ethylhexyl acrylate (2-EHA)(s), calculated from the dry weight of the acrylic adhesive. This kind of the adhesive may be particularly useful for wash-off adhesives. Further, the acrylate dispersion may not have strong effect on color of the layer, hence, visual appearance can be easily controlled.

The acrylic adhesive may further comprise one or more than one crosslinker. The one or more than one crosslinker can be selected from a group consisting of: allyl methacrylate (AMA), ethylene glycol dimethacrylate (eGDMA), triethyleneglycol dimethacrylate (TRGDMA), polyethyleneglycol 200 dimethacrylate (PeG200DMA), 1,3-butanediol dimethacrylate (1,3-BDDMA), 1,4-butanediol dimethacrylate (1,4-BDDMA), 1,6-hexanediol dimethacrylate (1,6-HDDMA), glycerol dimethacrylate (GDMA), trimethylolpropane trimethacrylate (TMPTMA), and diurethane dimethacrylate (HEMATMDI).

Particle size (nm) of the acrylic adhesive composition, measured as a mean particle diameter, can be in a range from 100 nm to 800 nm, preferably from 120 nm to 600 nm, more preferably from 140 nm to 500 nm, and most preferably from 150 nm to 400 nm. Particle size can affect to a behavior of the acrylic adhesive composition. With said range of 100 to 800 nm, and particularly with the most desired range from 150 nm to 400 nm, properties of the acrylic adhesive, such as solid content and viscosity levels, can be easily adjusted to a desired level.

Polymer gel content of the acrylic adhesive composition can be used for determining crosslinking level of the adhesive. Polymer gel content of the acrylic adhesive composition can be in a range from 20% to 90%, preferably from 45% to 85%, more preferably from 55% to 80% and most preferably from 60% to 75%, or from 65% to 75%. Thanks to said polymer gel contents, and particularly the preferred ranges, adhesion performance can be controlled to an improved level. Too high gel content can decrease adhesion performance, while too low gel content can increase adhesion performance too much.

In order to improve washability of the acrylic adhesive, the acrylic adhesive according to this specification comprises a wash-off additive comprising a grafted rosin ester. The wash-off additive can comprise an aqueous phase and resin particles dispersed in the aqueous phase.

The resin particles can comprise resinous material, which can be selected from a group consisting of a hydrocarbon resin, an alkyd resin, a polyamide resin, a rosin resin, and mixtures thereof. Preferably, the resinous material comprises or is the rosin resin. In an embodiment, an amount of the rosin resin is at least 50 wt. %, preferably at least 65 wt. %, such as at least 80 wt. %, and more preferably at least 90 wt. %, such as 100 wt. %, with respect to the resinous material. Said resinous material and particularly the rosin resin can improve performance of the wash-off additive.

An amount of the grafted rosin ester with respect to the resinous material in the wash-off additive may be at least 1 wt. %, for example, from about 1 wt. % to about 8 wt. %, preferably from about 2 wt. % to about 6 wt. %, such as from about 3 wt. % to about 5 wt. %. Thus, the effect of the wash-off additive in the acrylic adhesive can be improved.

The dispersion may further comprise e.g. an anionic emulsifier from 0.1 wt. % up to 3 wt. %.

The total amount of the resinous material, the grafted rosin ester, the optional anionic emulsifier, and water in the wash-off additive can be at least 95 wt. %, preferably at least 97 wt. %, such as at least 98 wt. %, and more preferably at least 99 wt. %, such as 100 wt. %, with respect to the total weight of the wash-off additive.

In an embodiment, resin particles of the wash-off additive have a mean particle diameter d50 of less than 1.2 microns, preferably less than 0.9 microns, wherein d50 means the mean particle diameter for the 50 wt. % fraction of the particles starting from the smallest particles.

Thus, as discussed, the wash-off additive can be an aqueous dispersion comprising the grafted rosin ester. The grafted rosin ester according to this specification is a rosin ester grafted with a capped polyalkylene glycol, wherein the capped polyalkylene glycol is a poly (alkylene glycol) alkyl ether.

The polyalkylene glycol can be selected from the group consisting of C2-C5 polyalkylene glycols and mixtures thereof. In an advantageous embodiment, the polyalkylene glycol is or comprises polyethylene glycol. The polyethylene glycol can be particularly suitable for improving washability properties of the wash-off additive.

The alkyl ether can have 1 to 18 carbon atoms, preferably 1 to 4 carbon atoms. Most preferably, for improving washability properties of the wash-off additive, the alkyl ether is a methyl ether.

Therefore, in an advantageous embodiment, the capped polyalkylene glycol is a methyl ether capped polyethylene glycol. This can particularly improve washability of the wash-off label comprising an acrylic adhesive in low temperature washing processes at +65° C., even when using low alkaline water of 1%. Further, by using a wash off additive comprising the rosin ester grafted with a capped polyalkylene glycol, wherein the capped polyalkylene glycol is the methyl ether capped polyethylene glycol, the PSA can be firmly remained attached to the face.

Therefore, in an advantageous embodiment, the wash-off additive comprises a rosin ester grafted with a methyl ether capped polyethylene glycol. This kind of wash-off additive can substantially improve washability of wash-off labels.

The capped polyalkylene glycol may have a Mw in a range between 1000 and 10000, preferably from 1000 to 8000. The average molecular weight of the end-capped polyalkylene glycol can be determined, e.g., by hydroxyl number analysis.

The molar ratio between the rosin ester and the capped polyalkylene glycol can be 0.05:1 to 1:1, preferably from 0.2:1 to 1:1, more preferably from 0.4:1to 1:1, and most preferably from 0.7:1 to 0.9:1. Said molar ratio can improve washability of the wash-off label.

Surprisingly, by using the wash-off additive comprising the grafted rosin ester in the acrylic adhesive, washability of the wash-off labels can be substantially improved. During experimental tests, this kind of effect was not seen with conventional rosin ester surfactant, nor with conventional polyalkylene glycols, such as polyethylene glycols.

The acrylic adhesive comprising a dispersion of acrylates and the wash-off additive can be extremely sensitive to washing conditions comprising a temperature of 65° C., and exposure to an aqueous alkaline solution, such as 1-2% NaOH. Further, the adhesion of the adhesive to the labelled item can decrease more than the adhesion to the face so that the adhesive remains attached to the face.

### Pressure Sensitive Adhesive Layer

The wash-off label can be affixed to the surface of an item (article) 100 through an adhesive layer 4 so as to form a labelled item 101. The wash-off label can comprise an adhesive layer sensitive to washing conditions.

An adhesive sensitive to washing conditions refers to such adhesives, wherein the adhesion of the adhesive decreases at washing conditions. The washing conditions generally comprise alkaline conditions and increased temperature. The increased temperature can be 65° C. The alkaline conditions refer to an aqueous solution containing alkaline agent, such as NaOH, KOH or combination thereof. Probably the most common alkaline agent is sodium hydroxide (NaOH), which is also called caustic soda. The alkaline conditions (i.e. the alkaline liquid) generally contains about 0.5-10% or 1-4% (by weight) of the alkaline agent(s), for example about 2%.

The adhesive layer of the label should have a suitable adhesion i.e. tack (stickiness) in order to stick to an item during labelling process. Tack is the property of adhesive that allows the immediate formation of a bond on contact with another surface. The tackiness is needed at the point the label is attached to an item. The optimum adhesion between two materials depends on, for example, the wetting and surface energy of the materials.

The adhesive layer 4 may be a continuous coating covering 100% of the face surface (referring to the first side of the face). Alternatively, the adhesive layer 4 may be applied discontinuously as spots or strips covering less than 100% of the first side of the face. For example, the adhesive may cover between 10 to 90% of the total area of the first side of the face. Reduced amount of adhesive may have effect on reducing the time needed for the subsequent removal of the label during washing process from the surface of the item attached. Thus, in an advantageous embodiment, the adhesive layer 4 covers less than 90%, more preferably less than 80% of the first side of the face.

An adhesive layer may have a thickness in the range of about 5-40 μm, or in the range of about 8-20 μm. For further improving efficiently of the washing, the thickness of the adhesive layer can be in the range of about 5-15 μm or 5-12 μm.

The amount of the adhesive layer, in dry weight, may be in the range of about 5-40 g/m², or 8-20 g/m². For improving efficiently of the washing, the amount of the adhesive can preferably be less than 20 gsm, such as equal or less than 15 g/m². For example, the amount of the adhesive layer is between 5 and 20 g/m² or between 5 and 15 g/m².

The wash-off label comprises the acrylic pressure sensitive adhesive (PSA). Labels having a PSA layer can be adhered to most surfaces through an adhesive layer without the use of a secondary agent, such as a solvent, or heat to strengthen the bond.

Generally the pressure sensitive adhesives can be divided into the following groups: water based (water-borne) PSA, solvent based PSA and solid PSA. Solid PSAs are melted during application to the surface to be coated and may also be referred to as a hot-melt PSAs. Within context of this specification, the pressure sensitive adhesive is preferably water-based PSA. Water-based adhesives can provide better sustainability with less fossil based raw materials and less volatiles involved both during the manufacturing and during end use. Furthermore, water based adhesives can be efficiently blended with the wash-off additive.

PSA according to this specification is acrylic-based. Thanks to the acrylic-based adhesive, the adhesive remains predominantly adhered to the film during the washing process. Thus, the adhesive according to this specification can be a water-based acrylic adhesive. The water-based acrylic adhesive can have many advantages over other kinds of PSAs. For example, tackiness of the product can be in an improved level thanks to the water-based acrylic adhesive. Further, the water-based acrylic adhesive may be environmentally friendly. Furthermore, the water based acrylic adhesive can be efficiently blended with the wash-off additive.

The pressure sensitive adhesive according to this specification can exhibit reduction in its adhesion force in aqueous alkaline conditions at a temperature of 65° C.

In order to further improve washability at 65° C., the acrylic PSA layer can exhibit at 65° C. a peel adhesion less than 4 N/25 mm at 65° C., measured according to FINAT standard FTM 2. This can improve easiness of label removal from the surfaces of bottles at the specified washing conditions. In an embodiment, peel value of the pressure sensitive adhesive is less than 2 N/25 mm at 65° C., or less than 1 N/25 mm at 65° C., measured according to FINAT standard FTM 2.

### Release Liner

Referring to FIG. 2, the label 2 may comprise a release liner 5. The release liner 5 is an optional feature.

The release liner 5 has a substrate 7 onto which a release coating layer 6, such as silicone, is applied.

Term “release liner” refers to a structure comprising a backing material layer as a substrate and a release coating layer on a surface of the substrate. In other words, the backing material is usually coated with a thin layer of release agent, such as silicone. The substrate of the release liner may be a paper based or film based substrate. The release coating layer provides a non-adherent surface i.e. low adhesion and release effect against the adhesive layer. The release liner protects the adhesive layer during shipment and storage. It further allows for efficient handling of individual labels after the labels are die-cut and the surrounding matrix is stripped up to the point wherein the individual labels are dispensed on a labelling line.

In labelling, the release liner is removed and disposed of, and the label is attached onto the surface to be labelled through the adhesive layer. Thus, release liners of the label laminates serve one or more useful functions: they are used as a carrier sheet onto which the adhesive may be coated; they protect the adhesive layer during storage and transportation; they provide a support for labels during die-cutting and printing, and ultimately, they release from the adhesive leaving it undamaged.

The face and the release liner are typically laminated together having an adhesive layer in between, which laminated structure is referred to as a label laminate.

If the wash-off label is a linerless label without the release liner, the wash-off label preferably has a release coating layer, such as a silicone layer, on top of the face (i.e., on the second side of the face).

### Article

One embodiment provides a combination of a wash-off label and an article. The article may be a package. In an advantageous embodiment, the article is a beverage bottle.

The wash-off labels may be in a form of a continuous label web having a plurality of individual labels wound into a roll. An automatic label dispensing machine can be configured to separate the individual labels from the label web and feed the labels onto a surface of a product to be labelled.

Labels may be used in wide variety of labelling applications and end-use areas, such as beverage labelling, food labelling, home, and personal care product labelling, and labelling of industrial products. The surface of the labelled article may be for example plastic, glass, metal, or paper based. The labelled article may be for example a container, such as a bottle, jar, canister, can, tin or the like. The label may also be applied to semi-rigid or flexible packages used for e.g. packaging of food.

An advantageous embodiment provides a use of a wash-off label for labelling of a beverage bottle. Examples of the beverage bottles include glass bottles, metal bottles, polyethylene terephthalate (PET) bottles, and bottles made of polyolefin, such as high density polyethylene (HDPE) and polypropylene (PP). The label may surround the labelled article, such as the beverage bottle, completely or partially. The beverage bottle is preferably a polyethylene terephthalate (PET) bottle or a glass bottle, most preferably the beverage bottle is the polyethylene terephthalate (PET) bottle. The beverage bottle can be a plastic bottle exhibiting heat shrinkage during wash.

In an advantageous embodiment, the wash-off label according to this specification is attached to a surface of a polyethylene terephthalate bottle. Such PET bottles are known to be thin bottles, which shrink at elevated temperature, and which will be crushed during the wash.

### Label Removal in Recycling Process

Removing the adhesive label can be implemented by washing said label off from the surface it has been adhered to. The item may be a recyclable container, such as a glass container or a polymer container.

Preferably, the item is a beverage bottle that can be a plastic bottle exhibiting heat shrinkage during wash.

Labelled items, such as bottles, are generally reused or recycled several times. Because polymeric labels do not possess the water permeability of the paper labels, the polymeric labels may be more difficult to remove completely with the existing washing process. Thus, there is a need for an improved label and face structures so as to would an efficient and cost-effective recycling process of the labelled items.

In the washing process the label is detached from the labelled item, for example from the surface of the bottle. During washing process, the label is exposed to a heated washing liquid. In washing process comprising heated aqueous washing solution, the shrinkable thermoplastic film is able to provide shrink force weakening the adhesion force of the adhesive layer thus detaching the adhesive label from the surface of the item attached. In addition, the adhesive layer 4 may lose its adhesion to at least some extent under the influence of washing conditions enabling and/or enhancing removal of the label from the surface of the item labelled.

In an example, the adhesive layer may not dissolve in the washing liquid. On the contrary, the adhesive layer may be adhered to the face after removal of the label from the surface of an item. Thus, lifetime of the washing solution can be prolonged.

Conventional washing conditions of recyclable containers, such as glass containers, can comprise temperatures above 77° C. in aqueous solution. For polyester or plastic containers, conventional washing temperature has been 70-75° C., or even higher such as about 80° C.

The novel wash-off label can have an improved washability already at 65° C. Thus, thanks to the wash-off label according to this specification, washability of labels can be improved so that washing at a temperature of 65° C. can show superior results compared to conventional wash-off labels.

### Experimental Tests

### Example 1

PET bottle recycling at +65° C.

Wash-off adhesive according to this specification, which comprised the grafted rosin ester comprising PEG, was blended with different water-based acrylic adhesives, and tested in wash-off tests at +65° C. in alkaline conditions having 1% NaOH.

The test points included the following amounts of the wash-off additive: 0%, 0.5%, 0.7%, 1.0%, 1.5%, 2.2%, 2.5%, 3%, 4%, 4.5% and 6% (by dry weight) from a total dry weight of the acrylic adhesive. For these tests, machine oriented and biaxially oriented polypropylene films were used as the face film.

An addition of the wash-off additive of more than 0%, such as equal to or more than 0.5 wt. %, to 3 wt. % (by dry weight) clearly improved washability at +65° C. The best efficiency was found at about 0.5-3% concentration (by dry weight), after which the efficiency decreased with increased wash-off additive concentration.

According to the test results, an addition of the wash-off additive of equal to or more than 4 wt. % (by dry weight) was not as good for improving washability of the acrylic adhesive as the addition of equal to or less than 3 wt. %. Further, when amount of the wash-off additive was above 3 wt. % (by dry weight), washed adhesive particles were smaller.

According to the test results, addition of more than 0 wt. %, such as equal to or more than 0.5 wt. % (by dry weight) of the wash-off additive into the acrylic adhesive improved washability of the wash-off labels compared to the test point of 0 wt. %. With the addition of 0.7%, improvement in the washability was even more significant.

The best washability results were shown with the wash-off additive addition from 0.7 to 3%. For example, addition of 1.5% (by dry weight) of the wash-off additive into acrylic adhesives improved washability (i.e., PET delamination) up to 170%.

The addition of the wash-off additive up to 3 wt. % either improved or did not affect to the wet anchorage level of the acrylic adhesive (i.e., adhesive anchorage to the film after washing). Typically, the wet anchorage level was 100% during the experimental tests. Thus, the adhesive was always able to stay together with the face film.

### Example 2

### PET Bottle Recycling at +65° C., Comparative Examples

The machine oriented and biaxially oriented polypropylene films were used as the face film for these tests.

Conventional rosin ester dispersion without the wash-off additive was blended with different water-based acrylic adhesives and tested in wash-off tests at +65° C. by using the same concentration range as in the Example 1.

Further, conventional PEG-solution was blended with different water-based acrylic adhesives and tested in wash-off tests at +65° C. by using the same concentration range as in the Example 1.

An addition of the conventional rosin ester dispersion did not improved washability at +65C. On the contrary, the conventional rosin ester dispersion decreased the washability, and the adhesive was poorly washable, or not at all washable.

Further, an addition of the PEG-solution did not improved washability at +65C, and the adhesive was poorly washable, or not at all washable. Further, in some test points, the addition of the PEG-solution decreased significantly wet anchorage of the adhesive during washing, hence, the adhesive was not always able to stay together with the face film. In some test points, wet anchorage level was as poor as about 0%.

### Example 3

### Tackification

The wash-off additive was formulated with different water-based acrylic adhesives and tested for tackification.

The wash-off additive according to this specification did not have any effect on the tackification. Thus, the wash-off additive was not able to work as a tackifier for the acrylic adhesive.

Further, comparative samples were manufactured by blending conventional rosin ester dispersion with different water-based acrylic adhesives. The conventional rosin ester dispersion was able to work as a tackifier.

### Example 4

### Hydrophobicity

The wash-off additive was formulated with different water-based acrylic adhesives and tested for hydrophobicity.

According to the test results, the wash-off additive clearly increased hydrophobicity, further improving washability of acrylic adhesives comprising the wash-off adhesive and improving delamination of labels from PET bottles.

The novel wash-off additive had many advantages over conventional solutions during the experimental tests. Conventional rosin ester dispersions were not able to work as a wash-off additive. Further, PEG solution was not improving wash-off properties of acrylic adhesives at all. Surprisingly, the wash-off additive according to this specification comprising the grafted rosin ester was able to efficiently improve acrylic polymer wash-off properties in low temperature washing processes at +65° C., and was able to improve delamination during washing process.

The invention has been described with the aid of illustrations and examples. The invention is not limited solely to the above presented embodiments but may be modified within the scope of the appended claims.

1. A method for manufacturing a wash-off label comprising a face and a pressure sensitive adhesive layer for adhering the wash-off label to a surface of an item to be labelled, wherein the face comprises a thermoplastic film,
wherein the method comprises:
applying an acrylic adhesive onto a first surface of the face, wherein the acrylic adhesive comprises a wash-off additive, the wash-off additive comprising preferably
a resinous material, and
a grafted rosin ester which is a rosin ester grafted with a capped polyalkylene glycol, wherein the capped polyalkylene glycol is a polyalkylene glycol end-capped by an alkyl ether,
drying the acrylic adhesive in order to form an acrylic pressure sensitive adhesive onto the first surface of the face,
thereby obtaining the wash-off label.

2. The method according to claim 1, wherein a polymer gel content of the acrylic adhesive is at least 60% and 75% at the most.

3. The method according to claim 1, wherein a mean particle size of the acrylic adhesive is at least 100 nm and 800 nm at the most, measured as a mean particle diameter.

4. A wash-off label comprising a face and a pressure sensitive adhesive layer for adhering the wash-off label to a surface of an item to be labelled,
wherein the face comprises a thermoplastic film, and
the pressure sensitive adhesive layer comprises
an acrylic pressure sensitive adhesive comprising a wash-off additive, the wash-off additive comprising
a resinous material, and
a grafted rosin ester which is a rosin ester grafted with a capped polyalkylene glycol, wherein the capped polyalkylene glycol is a polyalkylene glycol end-capped by an alkyl ether.

5. The wash-off label according to claim 4, wherein an amount of the wash-off additive is equal to or more than 0.5 wt. %, calculated from total dry weight of the acrylic adhesive.

6. The wash-off label according to claim 4, wherein an amount of the wash-off additive is equal to or less than 3 wt. %, calculated from total dry weight of the acrylic adhesive.

7. The wash-off label according to claim 4, wherein an amount of the grafted rosin ester with respect to the resinous material is from 1 wt. % to 8 wt. %.

8. The wash-off label according to claim 4, wherein the polyalkylene glycol is a polyethylene glycol.

9. The wash-off label according to claim 4, wherein the thermoplastic film is biaxially oriented.

10. The wash-off label according to claim 4, wherein the thermoplastic film is monoaxially oriented, which is monoaxially oriented in a machine direction of said film.

11. The wash-off label according to claim 4, wherein the acrylic adhesive comprises 2-ethylhexyl acrylate.

12. The wash-off label according to claim 4, wherein the resinous material comprises or consists of the rosin resin.

13. The wash-off label according to claim 4, wherein a molar ratio between the rosin ester and the capped polyalkylene glycol is 0.05:1 to 1:1.

14. The wash-off label according to claim 4, wherein the alkyl ether is a methyl ether.

15. The wash-off label according to claim 4, wherein the face is configured to shrink.

16. The wash-off label according to claim 1, wherein the thermoplastic film comprises a polypropylene film.

17. The wash-off label according to claim 4, wherein the thermoplastic film comprises a glycol modified polyethylene terephthalate film.

18. The wash-off label according to an claim 4, wherein the wash-off label is a linerless wash-off label.

19. The wash-off label according to claim 4, wherein the wash-off label is a wash-off label laminate comprising a release liner.

20. An article comprising the wash-off label according to claim 4 adhered to a surface of the article.

21. A beverage bottle; comprising the wash-off label according to claim 4 adhered to a surface of the bottle.
